(19) United States
(12) Patent Application Publication
(10) Pub. No.: US 2012/0311956 A1
(43) Pub. Date: Dec. 13, 2012

(54) GRATING SYSTEMS INCORPORATING DECORATIVE ARTICLES

(76) Inventor: Steven M. Akkala, Neenah, WI (US)

(21) Appl. No.: 13/154,783

(22) Filed: Jun. 7, 2011

(51) Int. Cl. E04C 2/42; B23P 11/00

(52) U.S. Cl. 52/660; 29/428

(57) ABSTRACT

A grating system includes at least one pocket for supporting a decorative element within the grating system. The decorative element can be a brick and the pocket includes a size and shape configured to house the brick in close fitting relation while the upper surface of the brick is generally aligned with the upper surface of the grating system.

### FIELD OF THE INVENTION

The present invention relates to grating systems incorporating at least one decorative article therein to enhance the appearance of the grating system and surrounding landscape.

### BACKGROUND

Property owners and developers are constantly seeking new ways to enhance the designs of courtyards, parks, malls, city streets, and other public and private grounds. Because such areas are often accessible to large numbers of people, features incorporated into the landscape design should be designed with safety as a primary concern. In addition, the features should be designed to withstand prolonged exposure to rain, snow, and other deleterious elements. Grating systems have been employed around trees, fountains, or as a walking surface to meet the safety and durability requirements. Grating systems rely on the shape, texture, and configuration of the grating elements to enhance its appearance. Consequently, the variety of designs is somewhat limited.

There remains a need for grating systems that meet the necessary safety and durability requirements while also providing means to enhance the appearance of the grating system itself and thereby refine the surrounding landscape.

### SUMMARY

The present invention provides a grating system that includes at least one pocket for supporting a decorative element within the grating system. In one embodiment, the decorative element is a brick and the pocket includes a size and shape configured to house the brick in close fitting relation while the upper surface of the brick is aligned with the upper surface of the grating system. When the brick is positioned in the pocket, a gap exists between the sides of the brick and the sides of the pocket to allow water passage therethrough. The pocket also includes a bottom opening to allow water drainage around the brick.

In another embodiment, the grating system includes a plurality of receptacles to house respective ones of a plurality of decorative elements, such as brick-like elements. Various shapes for the pocket and decorative element are contemplated, including rectangular, cubical, cylindrical and prismatic shapes.

The present invention also provides a method for manufacturing a grating system. The method includes forming a grate of the grating system with a pattern of holes extending through the grate and solid portions around the holes, and interrupting the solid portions with a pocket that is recessed into the grate. The pocket is sized and shaped to receive and support a brick-like decorative element so that the decorative element is incorporated into the grate. This maintains the relative positioning between the grate and brick so that positioning of the brick is maintained, preserving the aesthetic appearance and preventing the brick from becoming a tripping hazard. The pocket is formed by a plurality of side elements extending distally from a proximal support surface of the grate and by a plurality of inwardly extending support elements extending from the side elements. The support elements define a through-opening so that water passing through gaps between the brick and the side elements has a means for escape. In one embodiment, the side elements and support elements are cast as one piece with the grate to provide a durable support that does not allow settling of the brick relative to the grate. In one embodiment, the grate includes a plurality of pockets to house a plurality of decorative elements. In one specific embodiment, the brick-like decorative elements include text and/or figures inscribed thereon to convey a message. However, plain decorative elements are also contemplated.

The present invention also provides a method for assembling a grating system. The method includes positioning a grate of the grating system in a landscape and positioning at least one brick into at least one pocket of the grate so that the grate provides a decorative pattern formed by a plurality of holes through the grate and the at least one brick. In one embodiment, the method includes positioning a plurality of bricks into a plurality of pockets formed in the grate. In a further embodiment, at least one of the plurality of bricks includes a commemorative inscription.

These and other aspects of the invention arc further discussed below with reference to the figures submitted herewith.

### BRIEF DESCRIPTION OF THE DRAWINGS

FIG. 1 is a plan view of one embodiment grating system according to the invention in which a grate includes pockets for housing decorative elements.

FIG. 2 is a section view of the grating system of FIG. 1.

FIG. 3 is a plan view of a grate section of the grating system with the decorative element removed from the pocket.

FIG. 4 is a plan view of another embodiment grating system according to the invention.

FIG. 5 is a plan view of another embodiment grating system according to the invention.

FIG. 6 is a plan view of another embodiment grating system according to the invention.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any such alterations and further modifications in the illustrated devices, and such further applications of the principles of the invention as illustrated herein are contemplated as would normally occur to one skilled in the art to which the invention relates.

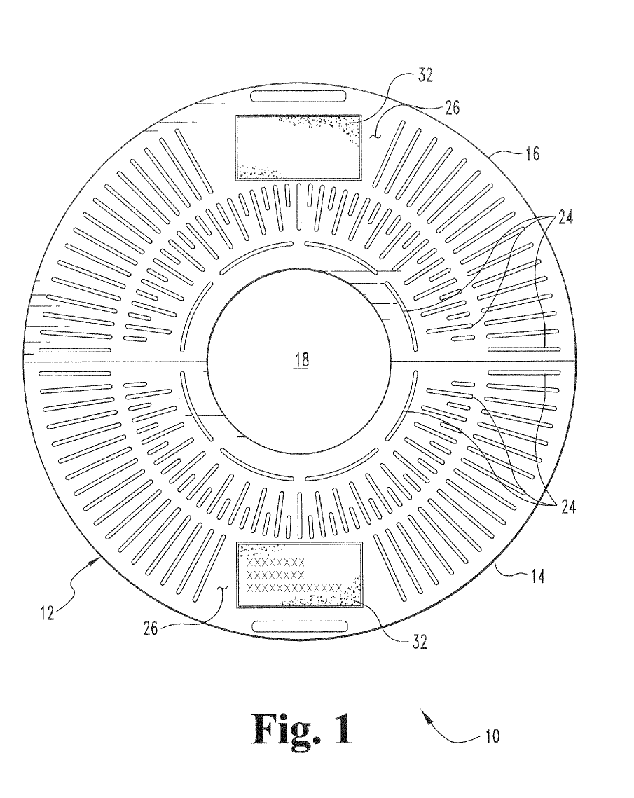

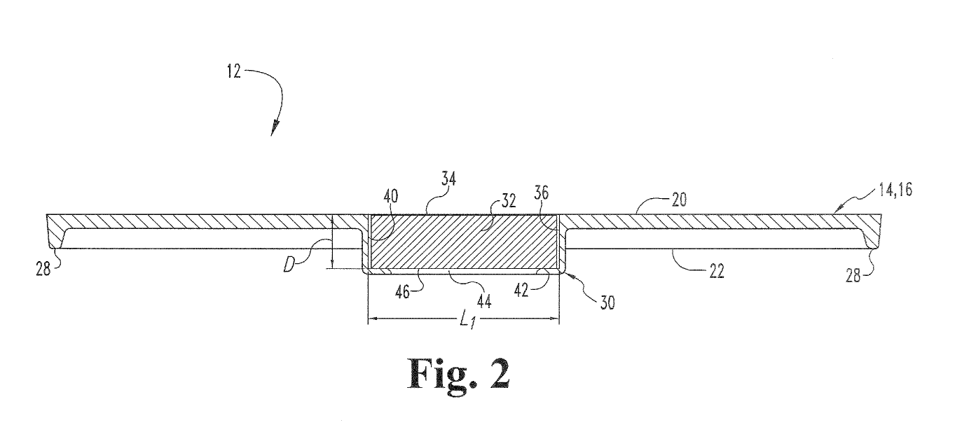

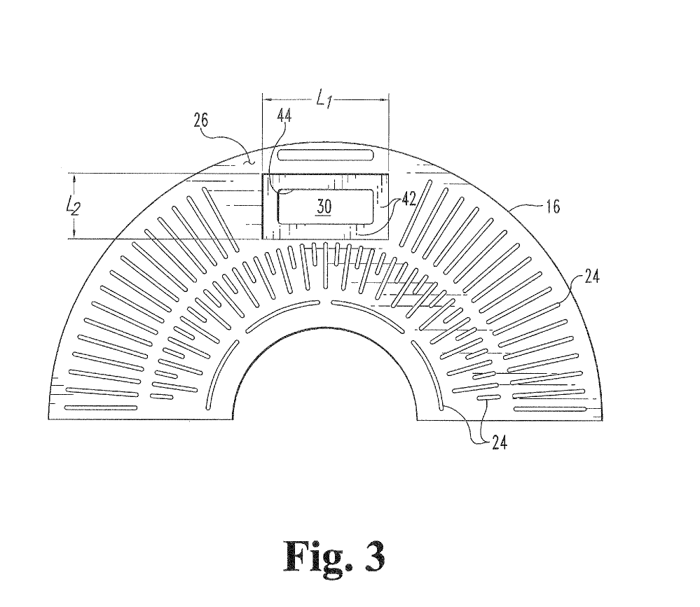

Referring first to FIG. 1, a grating system 10 is shown that includes a first grate section 14 and a second grate section 16 that are assembled to form a grate 12 for positioning in a landscape. Grate 12 includes a passage 18 through which extends a tree, pole, bush, fountain, or other landscape article or structure. Although illustrated as being circular, passage 18 could, of course, he configured in various geometric shapes, such as a square, rectangle, or triangle, for example. In addition, passage 18 can be located in the center of grate 12 as shown, or offset from the center of grate 12, or omitted from grate 12. Grating system 10 may also include fasteners or anchors to secure grate sections 14, 16 to one another, to secure grate sections 14, 16 to a frame in which grate sections 14, 16 are positioned, and/or to secure grate sections 14, 16 to surrounding pavement or other structures in which gating system 10 is to be set.

Grate 12 includes an upper or proximal side 20 and an opposite lower or distal side 22. Grate 12 also defines a grating network that includes plurality of openings 24 that extend through and open at the proximal and distal sides 20, 22 and solid portions 26 between and around openings 24. Openings 24 define a pattern through grate 12 to provide a desired ornamental appearance while also allowing water to pass through the grate 12. In the illustrated embodiment, the majority of openings 24 are elongated at various lengths in a radial direction extending outwardly from center passage 18, and a minority of openings 24 extend concentrically about center passage 18. Openings 24 may also form other patterns, including patterns that spiral around passage 18, patterns that are concentric around passage 18, patterns that are linear around passage 18, patterns that are polygonal around passage 18, patterns that form irregular shapes around passage 18, patterns that are floral or foliage in configuration, and combinations thereof. Although illustrated as being circular, grate 12 could, of course, be configured in various geometric shapes, such as a half circle, square, rectangle, elliptical, or triangle, for example. In addition, the proximal side 20 of grate 12 can be textured or include a decorative pattern. Proximal side 20 of grate 12 can also be contoured or warped slightly to promote drainage toward the outer edge of grate 12.

Grate 12 further includes solid portions 26 between and around openings 24 that provide structural support for, for example, vehicular or pedestrian traffic. Solid portions 26 extend to an outer support frame 28 that extends around the perimeter of each grate section 14, 16. Outer support frame 28 may include one or more lugs, flanges and/or holes (not shown) to receive bolts, rods, or other anchors to secure grate sections to the surrounding concrete, pavers, or supplemental frame section. In addition, grate sections 14, 16 may include holes in portions of frame 28 that abut one another to allow adjacent frame sections to be secured to one another with a fastener. Grate sections 14, 16 may also include one or more interior support ribs (not shown) extending along distal side 22 to provide additional structural support.

Grate 12 includes at least one pocket 30 formed in solid portion 26 thereof that receives a decorative element 32 so that decorative element 32 is incorporated into the grating network to provide an aesthetically pleasing and refined appearance. The decorative element 32 is a brick in the illustrated embodiment with a rectangular prism or box shape. However, other embodiments contemplate decorative elements 32 with other shapes, including cubical shapes; cylindrical shapes with, for example, cross-sections such as circular or elliptical cross-sections; or regular or irregular prism shapes. Pocket 30 is sized and shaped to receive the decorative element 32 in close fitting relation so that the decorative element 32 is housed in grate 12 and incorporated into the aesthetics of grate 12. For example, pocket 12 includes a depth D extending from proximal side 20 so that the proximal surface 34 of decorative element 32 is aligned with proximal side 20, preventing decorative element 32 from forming a tripping hazard and providing an integrated aesthetic with grate 12. This also aligns proximal surface 34 with proximal side 20 to provide a smooth surface and prevent the decorative element 32 from recessing into grate 12, allowing it to remain ready visible.

Pocket 30 also includes lateral dimensions L1 and L2 that closely match the lateral dimensions of decorative element 32 while providing a small gap 36 between sides 38 of pocket 30 and sides 40 of decorative element 32. Gap 36 allows water to pass therethrough to prevent ponding on the proximal side 20 of grate 12. Pocket 30 includes distal support elements 42 extending transversely to sides 38 and toward one another at the distal side of pocket 30. Distal support elements 42 define a through-opening 44 that allows water from gap 36 to pass therethrough to prevent ponding at the distal side 46 of decorative element 30, which could heave the decorative element 32 from pocket 30 upon freezing.

Grate 12 can be made from cast iron or other suitable metal such as steel, aluminum or bronze materials, plastic materials, or other suitable material and composites thereof. In one embodiment, grate sections 14, 16 are cast iron and formed as a single, integral one piece unit which includes pocket 32 formed with and depending from solid portions 26. Grate sections 14, 16 can be secured to one another with fasteners, or remain unsecured to one another. In addition, grating system 10 can be comprised of more than two grate sections, or by a single grate section.

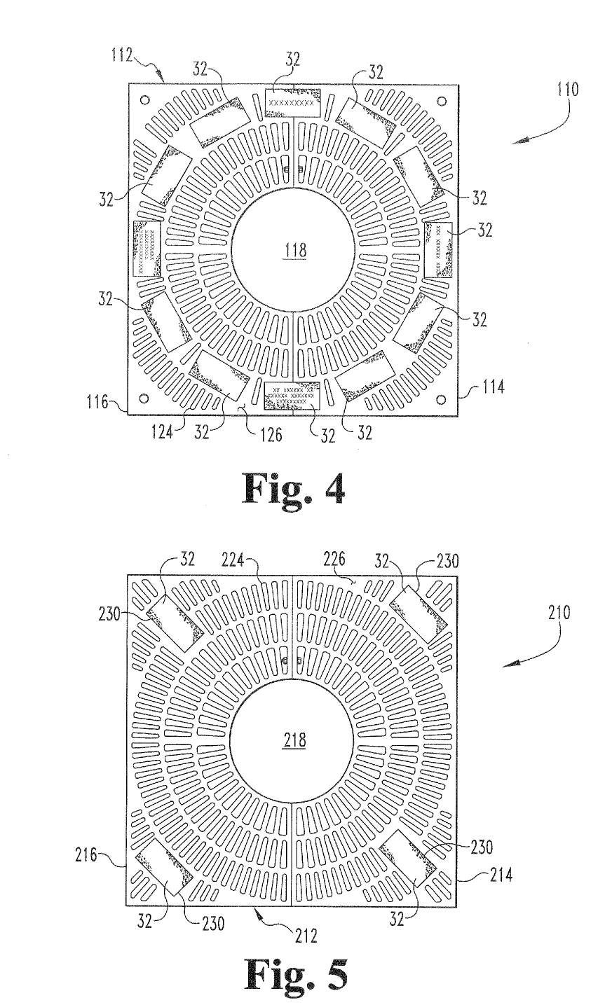

FIGS. 4-6 show other embodiment grate systems which incorporate a plurality of decorative elements 32 into their grating patterns. For example, in FIG. 4, grating system 110 in FIG. 4 includes grating sections 114, 116 that form a square or rectangular grate 112. Openings 124 are arranged to extend radially from center passage 118. In addition, a plurality of pockets 130 are formed in solid portion 126 of grate 112 and are arranged in a concentric manner about center passage 118 to receive decorative elements 132 therein.

In another example, in FIG. 5 grating system 210 includes grating sections 214, 216 that form a square or rectangular grate 212. Openings 224 are arranged to extend radially from center passage 218. In addition, a plurality of pockets 230 are formed in solid portion 226 of grate 212 and are arranged at the corners of grate 212 to receive decorative elements 132 therein.

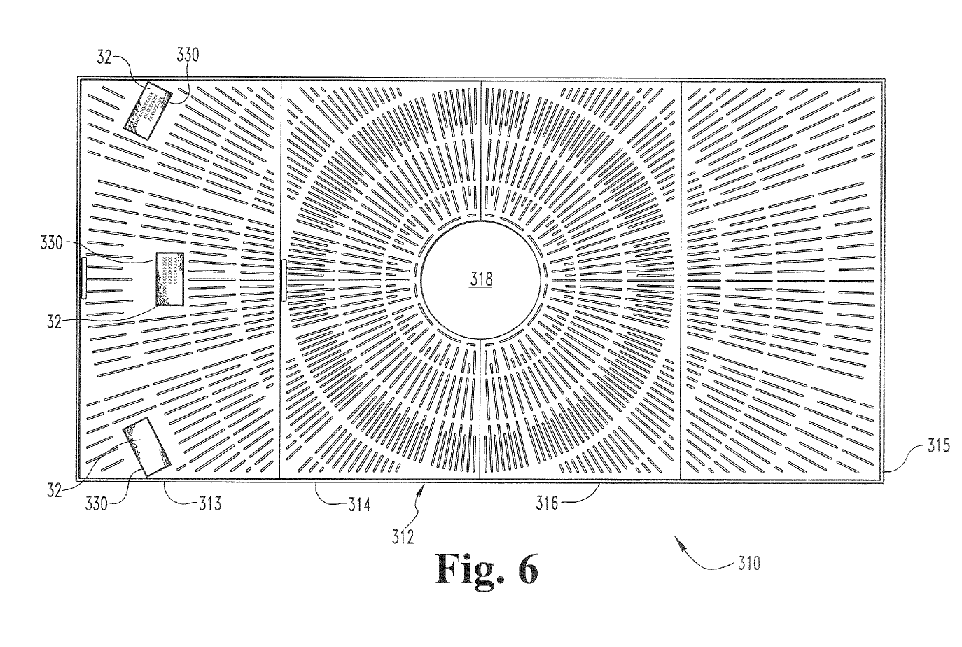

In another example, in FIG. 6 grating system 310 includes grating sections 314, 316 that form a square or rectangular grate 312 with center passage 318. In addition, grating system 310 includes supplemental grate sections 313, 315 at the opposite sides of grate 312 to extend the grating area. Grate section 313 includes pockets 332 in solid portions 326 thereof to receive decorative elements 32. In addition, grate sections 314, 315, 316 may include pockets to receive decorative elements 32.

Although various embodiments have been described as having particular features and/or combinations of components, other embodiments are possible having a combination of any features and/or components from any of embodiments as discussed above. As used in this specification, the singular forms “a,” “an” and “the” include plural referents unless the context clearly dictates otherwise. Thus, for example, the term “a member” is intended to mean a single member or a combination of members, “a material” is intended to mean one or more materials, or a combination thereof. Furthermore, the terms “proximal” and “distal” refer to the direction closer to and away from, respectively, an observer of the grating system when the grating system is employed for its ordinary purpose. For example, the portion of a grating system that is normally visible and facing the observer would be the proximal portion, while the opposite portion of the grating system (e.g., the portion of the grating system facing away or furthest away from the observer) would be the distal portion.

While the invention has been illustrated and described in detail in the drawings and foregoing description, the same is to be considered as illustrative and not restrictive in character, it being understood that all changes and modifications that come within the spirit of the invention are desired to be protected.

1. A grating system, comprising:
at least one decorative element; and
a grate including a support frame, an outer perimeter, and a proximal side surrounded by said outer perimeter, wherein said proximal side is defined by solid surface portions and a plurality of openings between said solid surface portions to form an internal grating network defining a pattern within said outer perimeter that is supported by said support frame, said proximal side further defining at least one pocket that interrupts and depends from said solid surface portions, said at least one pocket including a size and a shape to receive said decorative element so that said decorative element is supported in said pocket and incorporated into solid surface portions of said grating network with a proximal side of said decorative element aligned with said solid surface portions at said proximal side of said grate.

2. The grating system of claim 1, wherein said plurality of openings extend through said grate.

3. The grating system of claim 1, wherein said grate includes a distal side opposite said proximal side, and said pocket includes side elements extending distally from said solid surface portions and support elements extending toward one another transversely from distal ends of said side elements to form a support surface that is recessed distally from said proximal side and that contacts said decorative element in said pocket.

4. The grating system of claim 3, wherein said support elements define a through-hole to allow water passage therethrough.

5. The grating system of claim 4, wherein said side elements are spaced from one another so that a gap is formed between said side elements and said decorative element from said proximal side of said decorative element to said support elements, said gap allowing water to pass therethrough from said proximal side.

6. The grating system of claim 3, wherein said side elements and said support elements are formed integrally as one piece with said grate.

7. The grating system of claim 1, wherein said grate includes a distal side opposite said proximal side, and said pocket includes a depth extending distally from said proximal side sized so that said a proximal side of said decorative element is aligned with said proximal side of said grate and support elements at a distal end of said pocket contact and support said decorative element and extend from side elements of said pocket that depend distally from said solid surface portions.

8. The grating system of claim 1, wherein said at least one pocket includes a plurality of pockets to receive respective ones of a plurality of decorative elements.

9. The grating system of claim 1, wherein said grate defines a passage for receiving a landscape article therethrough.

10. The grating system of claim 9, wherein said grate includes first and second grate sections positioned relative to one another to define said passage.

11. A method for assembling a grating system, comprising:
positioning a grate in a desired location within a landscape, wherein the grate includes a plurality of openings extending therethrough that define a grating pattern and solid portions between and around the openings; and
positioning a brick in a pocket formed in the solid portions of the grate after positioning the grate so that the brick is supported by and incorporated into the grating system.

12. The method of claim 11, wherein a proximal side of the brick is aligned with a proximal side of the grate.

13. The method of claim 11, wherein the pocket is defined by side elements extending distally from the solid portions of the grate along sides of the pocket and support elements extending from distal ends of the side elements along a distal side of the pocket, and positioning the brick includes positioning the brick between the side elements and on the support elements.

14. The method of claim 13, wherein a gap exists between the brick and the side elements of the pocket from the proximal sides of the brick and a through-hole is formed by the support elements to allow water to pass from a proximal side of the grate through the through-hole.

15. The method of claim 13, wherein the side elements and the support elements are formed integrally as one piece with the grate.

16. The method of claim 11, wherein positioning the grate includes assembling first and second grate sections to one another to form a passage to receive a landscape article.

17. The method of claim 11, wherein the brick includes an inscription.

18. The method of claim 11, wherein the solid portions define a plurality of pockets and a plurality of bricks are positioned in respective ones of the plurality of pockets.

19. The method of claim 11, wherein the grate includes a distal side and an opposite proximal side, and the pocket includes a depth extending distally from the proximal side of the grate sized so that a proximal side of the brick is aligned with the proximal side of the grate and support elements at a distal end of the pocket contact and support the brick and extend from side elements of the pocket that depend distally from the solid portions of the grate.
